(19) United States
(12) Patent Application Publication
(10) Pub. No.: US 2026/0069987 A1
(43) Pub. Date: Mar. 12, 2026

(54) ARTIFICIAL-INTELLIGENCE ENABLED PLATFORMS AND METHODS FOR SELECTING MEDIA HAVING DEFINED CHARACTERISTICS

(71) Applicant: John Graham Cvinar, West Chester, PA (US)

(72) Inventor: John Graham Cvinar, West Chester, PA (US)

(21) Appl. No.: 19/320,415

(22) Filed: Sep. 5, 2025

Related U.S. Application Data
(60) Provisional application No. 63/693,479, filed on Sep. 11, 2024.

(51) Int. Cl. A63F 13/798; A63F 13/795; G06Q 30/0241; G07C 13/00

(52) U.S. Cl. CPC A63F 13/798; G07C 13/00; A63F 13/795; G06Q 30/0277

(57) ABSTRACT

Disclosed herein is a computer-based contest platform comprising: (1) an interface module configured to: (a) receive initial sponsor-provided guidance information regarding a contest; (b) provide the initial guidance information to contest entrants; and (c) receive content from the contest entrants, (2) a voting module configured to: (a) receive voter feedback from each of a plurality of voters regarding the received content and to generate using the voter feedback a voter ranking of the received content, and (3) an artificial intelligence module configured to calculate, using artificial intelligence, a first degree of alignment between the initial sponsor-provided guidance information and the received content, and to generate, using the first degree of alignment, a first AI ranking of the received content.

### RELATED APPLICATION(S)

This application claims the benefit of U.S. Application No. 63/693,479, filed on Sep. 11, 2024. The entire teachings of the above application(s) are incorporated herein by reference.

### BACKGROUND

It is known in the art to use a distributed network of resources to evaluate a collection of materials. It is also known that in some cases, the resources consist of online individuals who vote on or otherwise evaluate content (e.g., images, video) in the context of an online contest. Often, such contests are sponsored, and the sponsoring entity desires to promote brand awareness, encourage the creation of on-point brand content, and incentivize these activities by awarding a reward to the winner. At the same time, there can be a misalignment between contest entries that resonate with voters and those that adhere to brand values. Accordingly, there is a need in the art for improved systems and methods for identifying and selecting media content having characteristics reflective of brand identity.

### SUMMARY OF THE INVENTION

In some embodiments disclosed herein is a contest platform comprising:
(1) an interface module configured to:
   (a) receive initial sponsor-provided guidance information regarding a contest;
   (b) provide the initial guidance information to contest entrants; and
   (c) receive content from the contest entrants (i.e., contestant content),
(2) a voting module configured to:
   (a) receive voter feedback from each of a plurality of voters regarding the received content and to generate using the voter feedback a voter ranking of the received content, and
(3) an artificial intelligence module configured to calculate, using artificial intelligence, a first degree of alignment between the initial sponsor-provided guidance information and the received content, and to generate, using the first degree of alignment, a first AI ranking of the received content.

In some embodiments disclosed herein is a computer-implemented method of evaluating media content, the method comprising:
receiving, in memory, (i) content from contest entrants, and (ii) voter feedback from each of a plurality of voters regarding the received content;
generating, using the voter feedback, a voter ranking of the received content; and
calculating, using artificial intelligence, a first degree of alignment between an initial sponsor-provided guidance information and the received content, and generating, using the first degree of alignment, a first AI ranking of the received content.

In some embodiments disclosed herein is a computer program product for evaluating media content, the computer program product comprising at least one non-transitory computer-readable storage medium providing at least a portion of computer code instructions that, when executed by a processor, cause an apparatus associated with the processor to:
a) receive (i) content from contest entrants, and (ii) voter feedback from each of a plurality of voters regarding the received content;
b) generate using the voter feedback a voter ranking of the received content; and
c) calculate, using artificial intelligence, a first degree of alignment between an initial sponsor-provided guidance information and the received content, and to generate, using the first degree of alignment, a first AI ranking of the received content.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of the platform architecture in one embodiment of the present invention.

FIG. 2 is a block diagram of an example platform integrated with a web portal server, network, and database, according to an embodiment.

FIG. 3 is a flowchart of a method of evaluating media content, according to an embodiment.

FIG. 4 is a schematic view of a computer network environment in which embodiments may be deployed.

FIG. 5 is a block diagram of a computer node in the computer network of FIG. 4.

FIG. 6 shows an example sign up/login mobile page for contest entrants and voters in an embodiment.

FIG. 7 shows an example login mobile page where a contest entrant's face is scanned to confirm identity in an embodiment.

FIG. 8 shows an example login mobile page where a contest entrant is allowed to start a challenge in an embodiment.

FIG. 9 shows an example search page for finding nearby challengers in an embodiment.

FIG. 10 shows results page of a search in which no nearby challengers are found, according to an embodiment.

FIG. 11 shows a successful match mobile page where a nearby challenger is found, according to an embodiment.

FIG. 12 shows an example voting page where voters can choose between two contest entrants in an embodiment.

FIG. 13 shows voting results page, according to an embodiment.

FIG. 14 shows an example viewing page of the winning contest entrant in an embodiment.

FIG. 15 shows an example viewing page of the losing contest entrant in an embodiment.

FIG. 16 shows an example mobile page of a sponsor (e.g., brand) setting up a Challenge/Theme and providing keywords for the challenge criteria in an embodiment.

FIG. 17 shows an example mobile page of a sponsor setting up a Challenge/Theme and providing images for the challenge criteria in an embodiment.

FIG. 18 shows an example mobile page of a sponsor setting up a Challenge/Theme and providing videos for the challenge criteria in an embodiment.

FIG. 19 shows an example mobile page of a sponsor setting up a Challenge/Theme and the challenge criteria in an embodiment.

FIG. 20 shows an example viewing page where the sponsor can monitor an ongoing challenge contest with voting results and brand relevance score calculated by AI.

The sponsor is allowed to edit the score.

### DETAILED DESCRIPTION OF THE INVENTION

A description of example embodiments follows.

Unless otherwise defined, all technical and scientific terms used herein have the same meaning as commonly understood by one of ordinary skill in the art. Those skilled in the art to which the present disclosure pertains may make modifications resulting in other embodiments or aspects employing principles of the present invention without departing from its spirit or characteristics, particularly upon considering the teachings herein. In case of conflict, the present specification, including definitions, will control. In addition, the embodiments, aspects, and examples are illustrative only and not intended to be limiting. Other features and advantages of the present disclosure will be apparent from the following detailed description, and from the claims. While the present disclosure includes references to particular embodiments and aspects, modifications of system architecture, configurations, and the like apparent to those skilled in the art still fall within the scope as claimed.

As used herein, “model” includes, and is not limited to, classification models, time series models, neural network models, linear regression models, logistic regression models, decision trees, support vector machines, Naive Bayes networks, k-nearest neighbor (KNN) models, k-means models, random forest models, association rule learning models, inductive logic programming models, reinforcement learning models, feature learning models, similarity learning models, sparse dictionary learning models, genetic algorithm models, rule-based machine learning models, learning classifier system models, or any combination thereof.

To determine prediction quality, the performance of the prediction model is evaluated in terms of various metrics such as accuracy, recall, precision, mean square error, etc., depending on the type of model. Prediction quality is also evaluated based on other factors including the amount of lead time before asset failure. For example, multiple models using the same historical sensor data may be generated but each with different lengths of time prior to predicted failure in order to identify at least one model with an acceptable accuracy at an acceptable prediction time before asset failure is expected to occur. If the evaluation of the model using a selected data set indicates that the model's predictions are inadequate with respect to quality, a decision to re-train the model may be made.

As used herein, “database” includes, and is not limited to, one or more databases configured as any suitable data store structure, such as a network, relational, hierarchical, multi-dimensional or object database. The database (or more generally data store) may be located within main memory (e.g., in the RAM) and/or within non-volatile memory (e.g., on a persistent hard disk). Database includes one or more databases deployed in an on-premise environment, cloud environment, and/or a combination thereof.

The present invention addresses the need for improved systems and methods for identifying and selecting media content having characteristics reflective of brand identity, such as by permitting iteration and synergy between crowdsourced (e.g., voter) evaluations of media content, and an artificial intelligence-based evaluation, with an AI system that is originally trained by sponsor-provided input, and re-trained based on a supplemental training set that is selected based, in part, on voter evaluations.

The present invention relates, in some aspects, to a sponsored contest platform (e.g., web-based contest platform) that solicits and selects winning submitted content based on both voter feedback and an artificial intelligence-based assessment of how well the content aligns with the sponsor's stated or otherwise expressed goals, such as the sponsor's desired brand messaging which includes keywords, images, audio content, and videos from the sponsor. The sponsor may be a company that wishes to generate buzz around a brand or a new product offering. Rather than directly creating or commissioning advertising content itself, as well as placing and managing this content on various ad websites, the sponsor is able to connect with content providers through the contest platform who can produce video, image, or textual submissions that relate to the brand or product. The sponsor is also able to reach the viewing public through the contest platform. As contests are hosted, voters view the sponsored content and are actively engaged in selecting and promoting quality content.

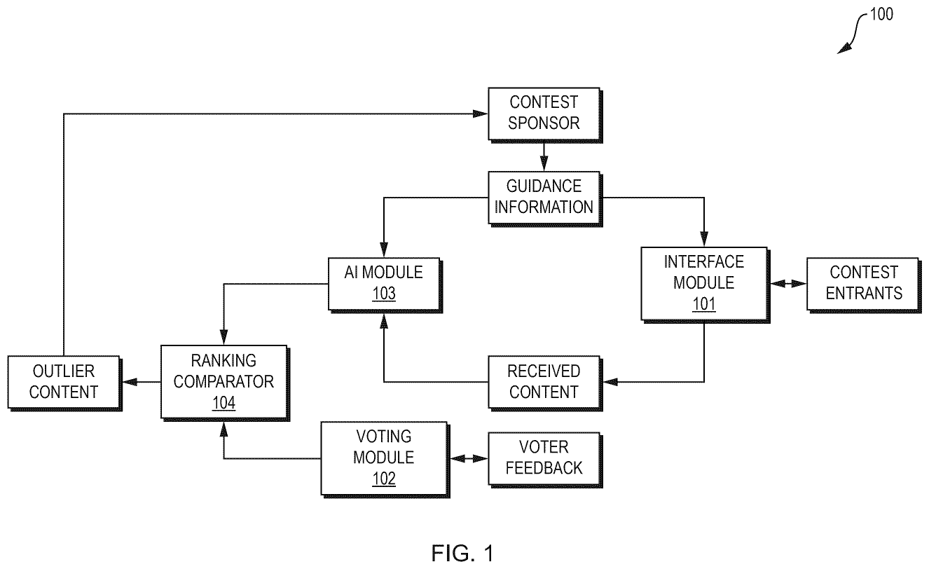

Embodiments of the present invention provide a contest platform 100 (FIG. 1 for non-limiting example). In some embodiments, the contest platform 100 supports workflows for evaluating media content.

Each component of the platform architecture, such as the interface module 101, voting module 102, AI (artificial intelligence) module 103, and ranking comparator 104, is installed on one or more underlying computing platforms, including on-premise platforms, cloud computing platforms and/or a combination thereof, such as hybrid cloud platforms. An on-premise platform is a computing platform that may be installed and operated on the premises of an entity such as a customer of the on-premise platform. A cloud computing platform may span wide geographic locations, including countries and continents. The service and/or application components (e.g., tenant infrastructure or tenancy) of the cloud computing platform may include nodes (e.g., computing devices, processing units, or blades in a server rack) that are allocated to run one or more portions of a tenant's services and applications. When more than one service or application is being supported by the nodes, the nodes may be partitioned into virtual machines or physical machines.

As illustrated in FIG. 1, communication between the respective components of contest platform 100 is possible using an API (Application Programming Interface) implemented to send and/or receive information between, for example, the AI module 103 and ranking comparator 104. Configuration of such API's employ technology and techniques that are common or known in the art and are within the purview of one skilled in the art given the disclosure herein.

In embodiments, the contest platform 100 accepts input from a sponsor (or other interested entity) of textual descriptions (or image examples) of desirable content to be solicited during the contest and makes related information available to contest entrants. The contest sponsor can be a company or other entity that wishes to promote a brand, product, charity, political party, social message, or the like. The contest platform 100 then accepts content submitted by entrants via an interface module 101 (FIG. 1) coupled to a user interface (e.g., graphical user interface such as a webpage, mobile page, or other online screen view in a browser window, tab or the like). For example, interface module 101, which includes logic, data handling, and backend services, is connected or integrated with a graphical user interface which provides visual and interactive components. Content submitted by entrants, or information provided by a sponsor regarding a contest, can include videos, as well as other types of media and multi-media, such as photographs, written works, graphics, musical works, images, textual materials, video stream, live visual content, audio content (e.g., live audio content, uploaded audio content), or a combination thereof.

Next, a voting module 102 (FIG. 1) accepts voter feedback (e.g., voter evaluations) of the entrant (contestant) submitted content and generates a voter ranking of the submitted content. Content can be, without limitation, videos, audio, graphics, images, or textual material. Voter evaluations can occur in different ways, such as in a comparison tournament (e.g., with pairwise selection of one out of two (or more) images as being superior), by scoring (e.g., users grading images content on a 1-10 scale), or in other ways. Voter evaluation information can be used to create scoring information (e.g., an average voter score or a numerical ranking), which is stored in association with each piece of evaluated content. Voters' evaluations may or may not reflect how well the content aligns with the sponsor's goals. In many cases, voters may simply choose content that they like for one reason or another. For this reason, it is desirable to independently evaluate contestant submitted content for alignment with the sponsor's goals.

The AI module 103 (FIG. 1) assesses this alignment with the sponsor's goals by performing an AI-based evaluation of the contestant submitted content. To achieve this, the sponsor trains an artificial intelligence (AI) model through the AI module 103 on content that aligns (or does not align) with desired brand attributes, such as brand identity. The AI module 103 may be configured to create, train, and execute one or more models for evaluating the submitted content. The AI module may be divided into individual processes. Each process may be in its own software container. For example, an architect process may be configured to create, instantiate, and decide the topology of the underlying AI model, while a training process can be configured to guide and perform the training of the model. An end user may interactively or otherwise define model parameters and algorithm parameters via AI module 103.

For nonlimiting example, in a “World's Best Looking Dog” contest, a sponsor may first provide sample videos, images, and words related to a dog as training materials for AI module 103. The AI module 103 would evaluate and assign a score to an animal entry submitted by a contestant (e.g., a cat entry would receive very low scores).

Training materials for AI module 103 may include, but not be limited to the textual descriptions of desired content provided to contest entrants. This can include criteria or training materials relating to desirable or undesirable aspects of user-generated (e.g., contestant-submitted) content. Criteria can be provided, for example, in a human readable language, and can relate to descriptors of style, quality, composition, or other descriptors that relate to the mood, tone, or other aesthetic attributes of solicited content. For example, such attributes of solicited content include perspective (e.g., mobile or landscape orientation) of contestant submitted content, sound quality/consistency, focus, framing of content, and steadiness of footage. Training material can also include examples of content together with one or more tags, such as numerical scores, indicating the degree of overall desirability in the eyes of the sponsor. Guidance information (or related information) can be made available to the users (contest entrants) who submit user-generated content. Guidance information can also be used to train an artificial intelligence model in AI module 103. Training materials can comprise materials provided by the sponsor. In the alternative, or in addition, training materials can include user-submitted materials that the sponsor has graded, ranked, tagged, or commented. Training materials may also be made available to contest entrants via a user interface, prior to submission of contest entries.

For nonlimiting example, the AI model in one embodiment is a fully connected neural network that may be represented as: for i=1, . . . n, Σf(cx)ᵢ. In the first layer (i=1), the weights c are in the range (0.2-1.5) representing relative score of keywords or key phrases in the training material (e.g., sponsor initial plus updated guidance information). In the second layer (i=2), the weights c are in the range (0.1-0.5) representing relative score or value of certain aesthetic attributes (e.g., tone and mood); and the third layer (i=3) weights c are in the range (0.1-0.2) for relative score or value of other aesthetic attributes (e.g., style). And so forth. Other value ranges for the weights and other functions per layer are suitable.

The trained model of the AI module 103 grades the submitted content along one or more dimensions, such as, for example, degree of general alignment with the guidance information (e.g., as reflective of desired on-brand messaging or content). The AI evaluations are stored in a database 106 in association with each piece of evaluated content, allowing them to be used as inputs for another model's calculations or for communication to the platform's users and other parts of the platform.

The contest platform 100 is configured to select one or more winning entries from the voter and/or AI evaluations (i.e., from the outputs of voting module 102 and of the trained model of AI module 103). In some embodiments, the contest platform 100 selects a winner based solely on the AI-based ranking or solely on the voter ranking, but in preferred embodiments, a winner is chosen based on both. For example, a total score for each piece of submitted content could be based on a weighted sum of scores of the voter scores (output from voting module 102) and the AI scores (output from AI module 103), e.g., 50/50 weight, 0/100, 100/0, 80/20, 25/75, 75/25, etc. The combined score could also be based on a sum of scaled or transformed scores. For example, scores associated with content could be plotted on a curve or other appropriate statistical distribution and transformed by assigning to each piece of content a scaled score corresponding to a positive or negative deviation from the mean. Other transformations, such as logarithmic transformations of the score are also possible.

In some embodiments, the AI module 103 of contest platform 100 accepts updated guidance information (e.g., AI training information) from the sponsor, based, for example, on the sponsor's evaluation of entries received during the contest. This evaluation is based on the sponsor's goals for the context, brand identity, and other factors of subjective importance to the sponsor. The AI model (of AI module 103) is re-trained or otherwise updated, and the AI evaluation is then re-run. For example, after a certain quantity of voter evaluation information is complied, e.g., based on a certain number of entries being voted upon, the sponsor may provide sponsor evaluations of some of the submitted entries and use these sponsor evaluations to provide updated training information (updated guidance information) to the AI module 103. In this manner, the sponsor can consider content, or aspects of content, that it may not have anticipated receiving, and to update the AI training data set accordingly. This permits the sponsor to refine the AI evaluation based on entrant submitted content. The sponsor can sample submitted content periodically throughout the submission/contest process, and provide updated training information to the AI model accordingly. At the end of the contest, the final AI evaluation, based on the refined/updated training, is used in weighted combination with the voter evaluations (see above), to determine a winning entry or entries.

In some embodiments, the contest platform 100 further aids in the selection of a subset of received entrant content that may be most worthwhile for the sponsor to evaluate for purposes of review/tagging/grading/updating the training set for the AI model at AI module 103. It has been recognized, in particular, that identifying the degree of alignment or correlation of voting rankings and AI rankings can be useful in the judicious selection of content for sponsor review. In embodiments, the contest platform 100 includes a ranking comparator 104 which compares the voter ranking (output from voting module 102) and the AI evaluations (e.g., AI ranking) from AI module 103. Techniques for performing such a comparison include, without limitation, correlation analysis, regression analysis, and non-parametric tests.

For example, submitted content that is highly scored by voters, but lowly scored by the trained AI model (i.e., where there is discordance between the scores) could be explained by the content having aspects that, while popular, are not aligned with brand values or identity as identified by AI based on the initial training dataset. Given the popularity with voters, however, it would be particularly worthwhile for sponsors to review these entries to either: (1) confirm agreement with the initial AI assessment (e.g., not on-brand messaging), but recognize that the messaging is in fact “on-brand” and there is a need to update the training data for the AI routine, or (2) even to recognize that while not originally thought to be “on brand,” the content is sufficiently good that the concept of on-brand should be modified/expanded.

In any event, the past and future contestant entries can be rescored by the AI model according to the new criteria/training sets, and the whole process can be iterated as desired. In this manner, voting scoring is used to help iteratively train the AI model and refine the AI module's ability to recognize (or perhaps even advance) the concept of brand identity or other desirable aspects of contest content as defined by a sponsor or other entity who sets these parameters.

It is anticipated that with this iterative training of the AI model (at AI module 103) based on detection and presentation of submissions with discordant AI/voter scores, the level of correlation between final AI scores (of AI module 103) and final voter scores (of voting module 102) will increase, though with persistent scatter and pockets of outliers. (For example, categories of content, e.g., material that appeals to certain popular aesthetics, is provocative, or contains prurient content may be highly rated by pockets of voters, but be enduringly off-limits to brand sponsors.) Here, too, identification of this content can be useful, such as in helping to inform the final weighting.

In some embodiments, the convergence between the AI-based scores and voter scores can also be guided by using the AI score (or a combination of a current AI score and current voter score) to influence future voter behavior. For example, based on AI score, certain entries can be eliminated from the contest, possibly by falling below a score threshold. Alternatively, if a piece of content's voter score is based not on an average score, but also based on how popular it is (i.e., number of times “liked” by voters when displayed alongside other images), and if the piece of content is displayed in reverse order of current rank, then this would tend to be a reinforcing mechanism whereby more popular highly liked content becomes more highly rated (and vice versa) merely by virtue of the extent of exposure to voters. In this manner, low interim AI scores can contribute to a low overall score, which in turn makes it more likely that the voter scores will drop. This encourages a desirable convergence of voter score-reflecting voter popularity-and AI score-reflecting sponsor values.

Some embodiments of the present invention therefore not only employ AI and voter ranking in complementary ways, but also do so dynamically, such as by using a degree of correlation vel non between interim AI scores and voter scores to identify submitted content for sponsor review and refinement of the AI algorithm, whereby the sponsor (via the AI algorithm) is potentially able to steer the AI score toward categories of material popular to voters, and voter scores can also be steered toward the AI scores by using interim total score rankings (voter plus AI) to position entries for predicted advanced or decline in the rankings as the content progresses.

In some embodiments, AI training data can be maintained or cumulatively enhanced across contests, and can serve as a useful tool for sponsors to engage the public in refining brand identity and/or identifying content that represents a desirable combination of on-brand messaging and popularity with the public.

In some embodiments, the contest platform 100 comprises: (1) an interface module (e.g., user interface module) 101 configured to: (a) receive initial guidance information, e.g. from a contest sponsor, regarding a contest; (b) provide the initial guidance information to contest entrants; and (c) receive content from the contest entrants, such as images, audio, graphics, video, or text; (2) a voting module 102 configured to: (a) receive voter feedback from each of a plurality of voters regarding the received content (from a contest entrant) and to generate using the voter feedback a voter ranking of the received content; (3) an artificial intelligence module 103 configured to calculate, using artificial intelligence techniques and algorithms, a first degree of alignment between the sponsor-provided guidance information and the received content (from the contest entrant), and to generate, using the first degree of alignment, a first AI ranking of the received content; (4) a ranking comparator 104, configured to: (a) compare the voter ranking and the first AI ranking of the received content (from the contest entrant); (b) identify outlier content from the comparison between the voter ranking and the first AI ranking; wherein: the interface module 101 is further configured to receive from the contest sponsor updated guidance information based on the sponsor's evaluation of the outlier content; and the artificial intelligence module 103 is further configured to calculate, using artificial intelligence techniques, a second degree of alignment between the whole of sponsor-provided guidance information (i.e., the initial and updated information) and the received content (from the contest entrant), and to generate, using the second degree of alignment, a second AI ranking of the received content; further wherein a contest winner is selected based on the second AI ranking.

In some embodiments, comparing the voter ranking and the first AI ranking of the received content (from the contest entrant) comprises correlating the voter ranking and the first AI ranking of the received content.

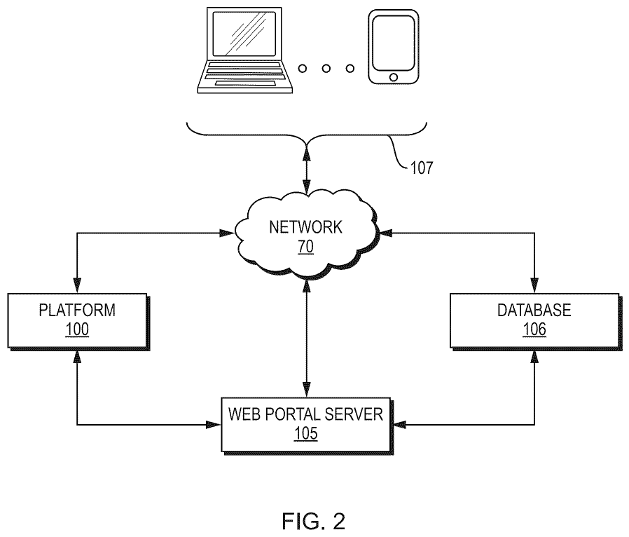

In some embodiments, contest platform 100 may be operated or accessed by users (e.g., contest entrants, voters, company, brand representatives, etc.). Users may access one or more modules (e.g., interface module 101, voter module 102) of contest platform 100 via a web portal server 105 (FIG. 2). For example, the AI module 103 may generate an AI-based ranking of the contest entries (e.g., images, video, audio, graphics, text, etc.), while the web portal server 105 may store and display the ranking to the user. In another example, the voting module 102 may generate a voter ranking of contest entries based on the voting results, while the web portal server 105 may store and display the ranking to the user. In some embodiments, users may access web portal server 105 via network 70 and one or more devices 107. Devices 107 may include any type of electronic device configured to send and receive data, such as websites and multimedia content, over network 70. For example, devices 107 may include one or more mobile devices, smartphones, personal digital assistants (“PDA”), tablet computers or any other kind of touchscreen-enabled device, a personal computer, a laptop, and/or server disposed in communication with network 70. Each of the one or more devices may have a web browser and/or mobile browser installed for receiving and displaying electronic content received from one or more of web servers (e.g., web portal server 105). Each of the one or more devices 107 may include client devices that may have an operating system configured to execute a web or mobile browser, and any type of application, e.g., a mobile application.

Any data provided by a user or generated by one or more modules of contest platform 100 may be stored in database 106. The contest platform 100 may use data from database 106 to improve the data collection and/or analytics of the contest platform 100 (e.g., using machine learning algorithms implemented by AI module 103 on data stored in database 106). Network 70 may include the Internet, a content distribution network, or any other wired, wireless, wide area network, and/or telephonic or local network. Contest platform 100, web portal server 105, database 106, and various devices 107 may communicate with each other via network 70 using known or common network protocols.

In some embodiments, interface module 101 is a set of data processing activities that prepares instructions for presenting on display screen of one or more end-user devices 107. Interface module 101 can, for example, select and display particular contests (e.g., challenges) which are nearby to a user, and respond to user interaction, for example, a user selecting a specific challenge and displaying relevant information about the selected challenge to the user.

In some embodiments, contest platform 100 may receive various user information from web portal server 105 and/or devices 107. User information may include one or more of: registration information, demographic information (e.g., age, gender, location, etc.), etc. In some embodiments, devices 107 may include a user's mobile phone. The user may log into web portal server 105 via the mobile phone (of devices 107) and access one or more modules of contest platform 100. Contest platform 100 may receive some user information from a mobile device (e.g., user location, age, etc.) and receive other user information from the web portal server 105.

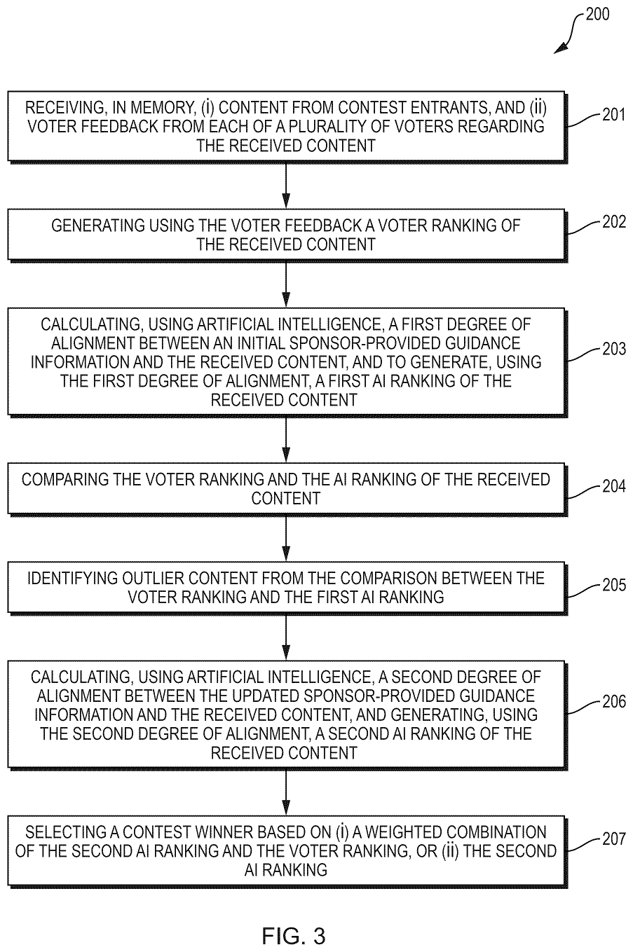

FIG. 3 is a flowchart of a method 200 of determining a layout of evaluating media content, according to an embodiment. The method 200 begins at step 201 by receiving, in memory of a processor (implementing the method), (i) content from contest entrants, and (ii) voter feedback from each of a plurality of voters regarding the received content (from contest entrants). At step 202, a voter ranking of the received content is generated using the voter feedback of step 201. Next, at step 203, using artificial intelligence techniques and algorithms (discussed above), a first degree of alignment between an initial sponsor-provided guidance information and the received content (from contest entrants) is calculated, and a first AI ranking of the received content is generated using the first degree of alignment.

The method 200 further comprises comparator step 204 comparing the voter ranking of step 202 to the first AI ranking of step 203. Next step 205 identifies outlier content from results of the step 204 comparison between the voter ranking (of step 202) and the first AI ranking (of step 203). Continuing at step 206, using artificial intelligence techniques, a second degree of alignment between the updated sponsor-provided guidance information and the received content is calculated, and a second AI ranking of the received content is generated using the second degree of alignment. At step 207, the digital processor executed method 200 selects a contest winner based on (i) a weighted combination of the second AI ranking and the voter ranking, or (ii) the second AI ranking (from step 206). The method 200 includes, and is not limited to, the computer implemented steps and stages as illustrated in FIG. 3.

### Platform Systems

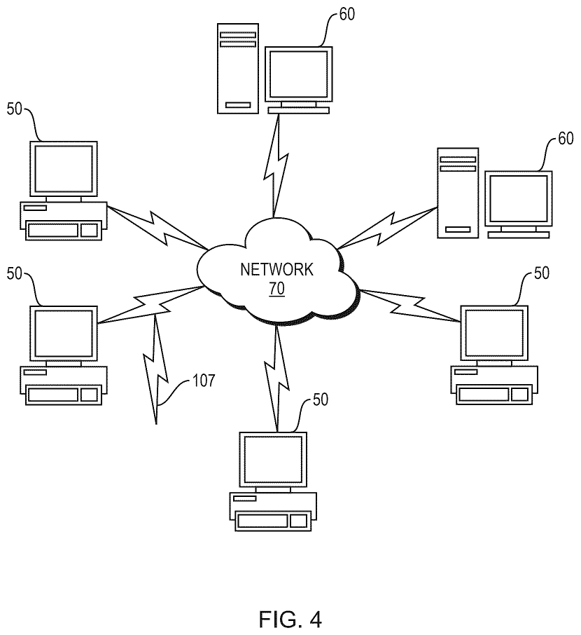

FIG. 4 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60.

Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

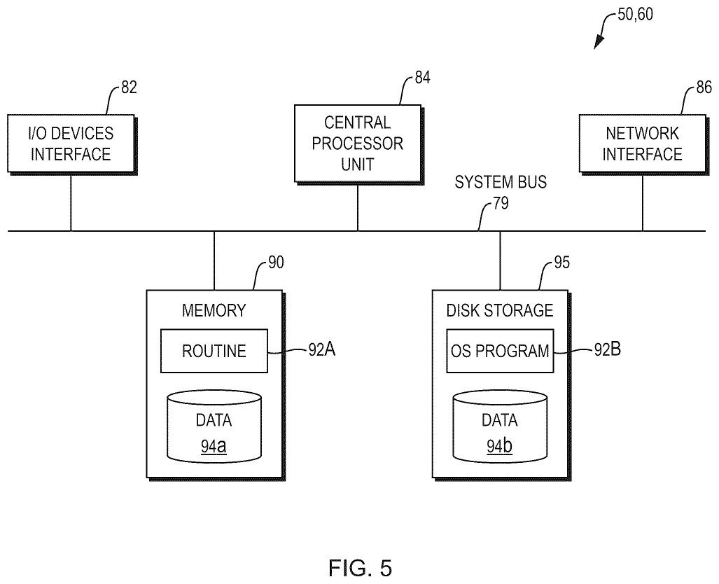

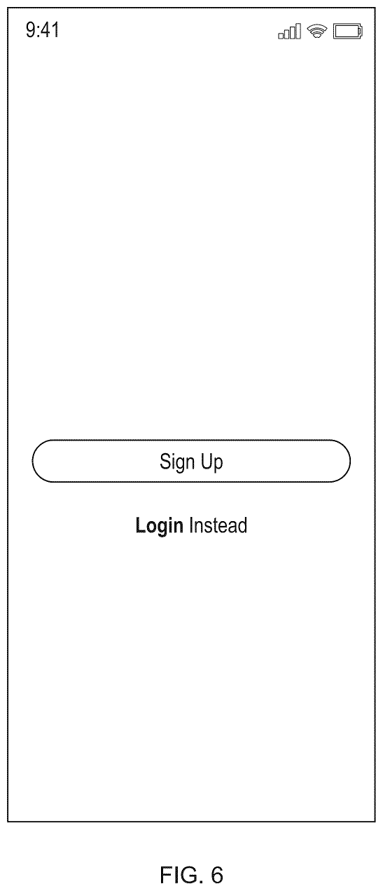

FIG. 5 is a diagram of the internal structure of a computer (e.g., client processor/device 50 or server computers 60) in the computer system of FIG. 4. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, display monitors, printers, speakers, etc.) to the computer 50, 60. Network interface 86 allows the computer to connect to various other devices attached to a network (e.g., network 70 of FIG. 4). Memory 90 provides volatile storage for computer software instructions 92A and data 94A used to implement an embodiment of the present invention (e.g., method 200 and related user interface views and operations as in FIGS. 6-20 for non-limiting example). Disk storage 95 provides non-volatile storage for computer software instructions 92B and data 94B used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In other embodiments, the program product 92 may be implemented as a so called Software as a Service (SaaS), or other installation or communication supporting end-users.

Specific details are given in the above description to provide a thorough understanding of the embodiments. However, it is understood that the embodiments may be practiced without these specific details.

The various illustrative embodiments described in connection with the disclosure herein may be implemented in hardware, software, or a combination thereof. For a hardware implementation, the embodiments may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of results of the executed function to the calling program (or program part) or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a computer-readable storage medium. A code segment or machine executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

Computer-readable medium includes both non-transitory computer storage medium and communication medium including any medium that facilitates transfer of a computer program from one place to another. A non-transitory computer-readable storage medium includes any available medium that can be accessed by a general purpose or special purpose computer. By way of example, and not limiting, non-transitory computer-readable storage medium can comprise Random Access Memory (RAM), read Only Memory (ROM), electrically Erasable Programmable Read Only Memory (EEPROM), flash memory, compact Disc (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital Subscriber Line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital Versatile Disc (DVD), floppy disk and blu-ray disc where disks usually reproduce data magnetically, while discs reproduce data optically with lasers. Combinations of the above are also included within the scope of computer-readable medium.

Other embodiments of the present invention include modifications made to the system, method, computer program product, and the like to prioritize memory usage or memory footprint goals, utilization goals for other resources such as CPUs, prediction-time goals (e.g., the elapsed time for a prediction run of the model), prediction-time variation goals (e.g., reducing the differences between model prediction times for different observation records), prediction quality goals, budget goals (e.g., the total amount that a user wishes to spend on model execution, which may be proportional to the CPU utilization of the model execution or to utilization levels of other resources), revenue/profit goals, and so on.

As used herein, the articles “a,” “an,” and “the” are used herein to refer to one or to more than one (i.e., to at least one) of the grammatical object of the article. By way of example, “an element” can mean one element or more than one element.

Also, the use of “or” means “and/or” unless stated otherwise. Similarly, “comprise,” “comprises,” “comprising” “include,” “includes,” and “including” are interchangeable and not intended to be limiting.

### EXAMPLES

### Example 1: Embodiments of Contest Platform 100 Accessed by a User on a Device

FIG. 6 shows an example of a sign up and login page on a mobile application accessed by users such as contest entrants and voters. Upon signing up and logging into the mobile application, users are greeted by a ‘Challenges’ page. The Challenges page allows contest entrants to participate in a variety of contests ranging from instant brain teasers to scheduled events. These contests or challenges are sorted based on the distance or proximity to the user as well as the type of challenge (e.g., instant challenge, event challenge). For non-limiting example, an instant challenge allows two or more people to participate in a contest with, or without, advance notification or warning (e.g., in a “World's Best Looking Dog” contest without any advance warning, a contestant may film a nearby dog). In an event challenge (e.g., “Who is the Best Next Singing in the USA? ”), for non-limiting example, content would be submitted with a higher emphasis on quality, production, and/or pre-production-planning.

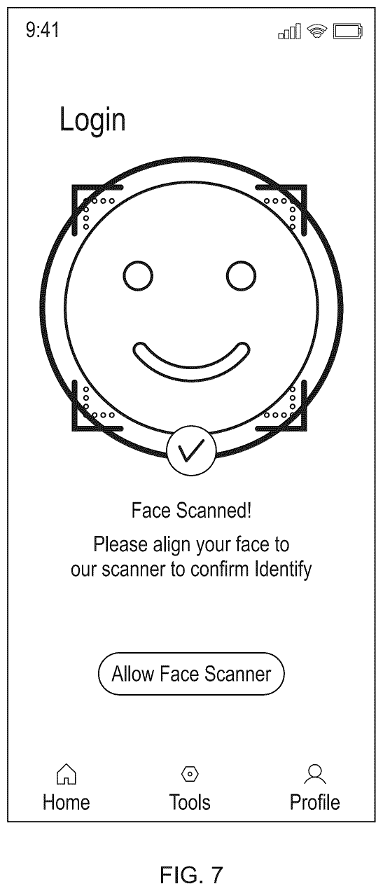

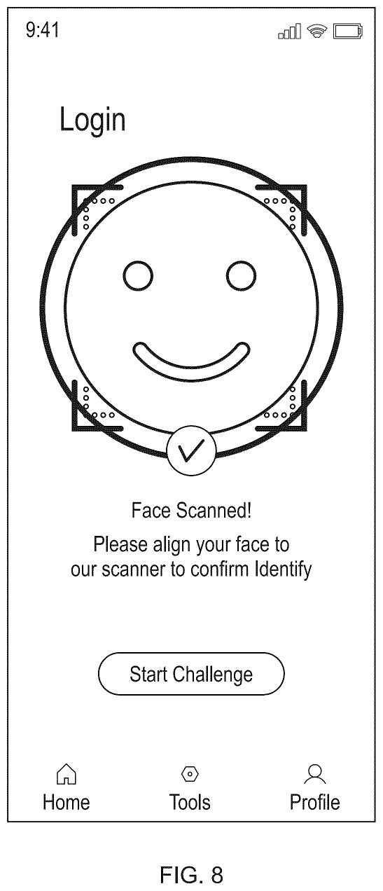

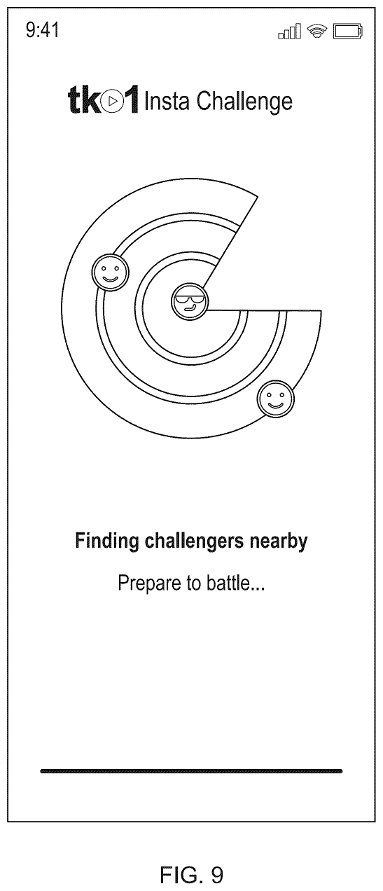

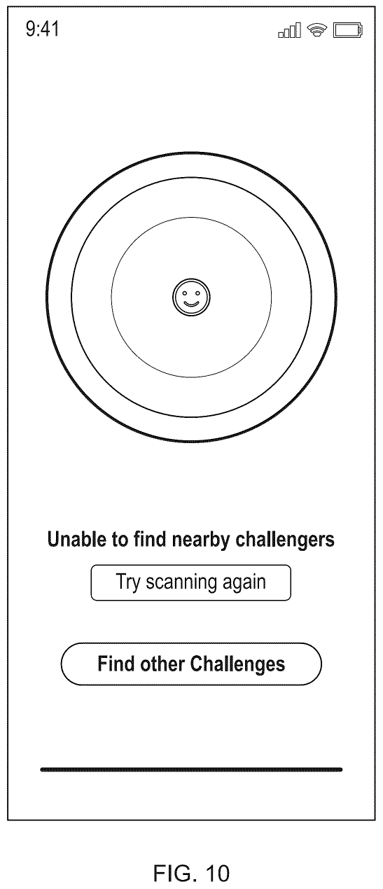

The number of current participants for each challenge type is also displayed. Contest entrants can upload entries based on a theme of a challenge, and compete against one another. Upon the end-user selecting a challenge from the Challenges page, the mobile device responsively performs a face scan to confirm the end-user's identity (FIG. 7) before starting a selected challenge. Following a face scan, the end-user is allowed to start a challenge (FIG. 8). FIG. 9 shows an example of an instant challenge where nearby challengers are being searched before the challenge commences. If no nearby challengers are found, the end-user can perform the search again, or find other challenges (FIG. 10).

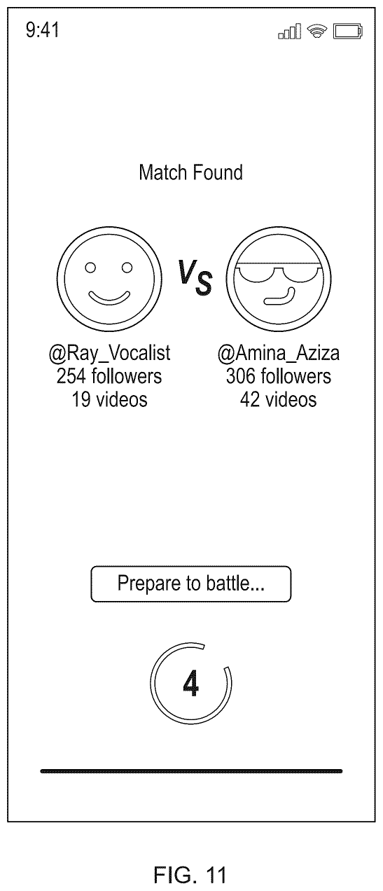

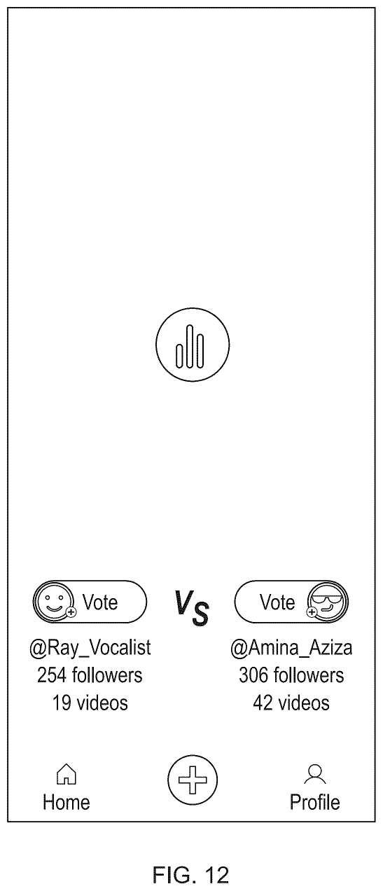

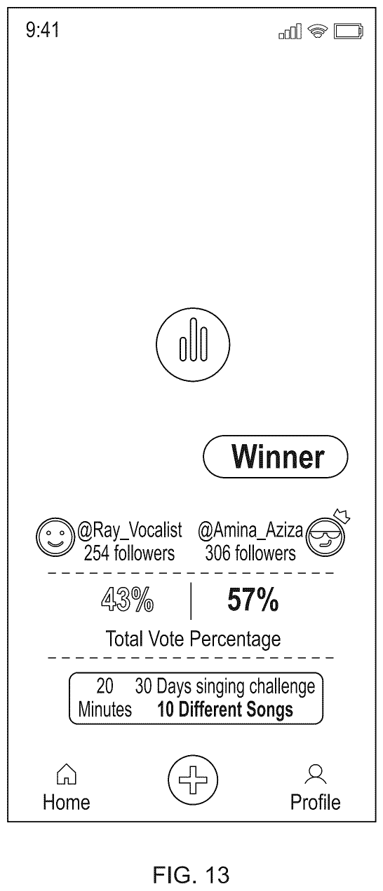

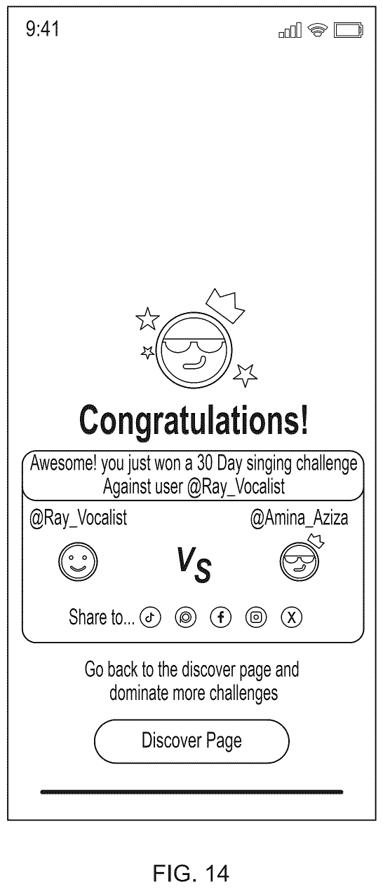

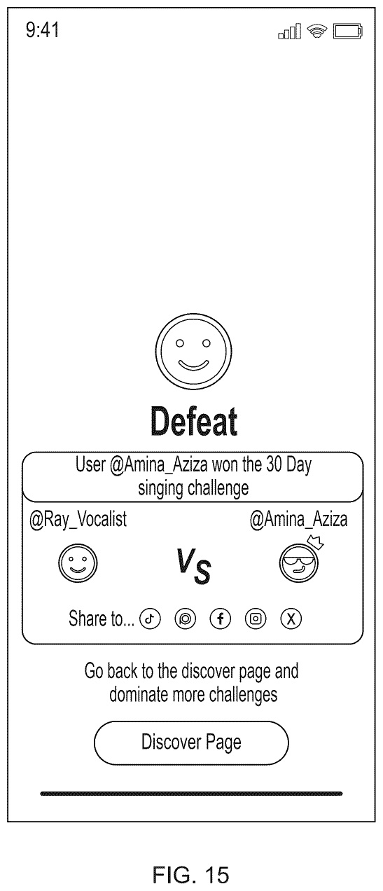

If a nearby challenger is found, both profiles (e.g., name of user, number of videos submitted, number of followers) of the challenger and the end-user are presented, as shown in FIG. 11. As shown in FIG. 11, user @Amina_Aziza has submitted 42 videos (i.e., contest entries) and has 306 followers, while user @Ray_Vocalist has submitted 19 videos and has 254 followers. Voters are allowed to cast their votes to select their preferred contestant (FIG. 12). Once the voting phase ends, the winner of the challenge is shown, along with the voting results and percentages. As shown in FIG. 13, user @Amina_Aziza garners 57% of the total voter percentage while user @Ray_Vocalist garners 43% of the total votes. The winner of a 30-day singing challenge, in this example, @Amina_Aziza, is presented with a congratulatory message in the mobile application (FIG. 14). User @Ray_Vocalist, is also presented with a message in the mobile application (FIG. 15). Both end-users (challengers) may share their results of the challenge on a variety of social media platforms.

### Example 2: Examples of Sponsor-Provided Guidance Information Regarding a Contest or Challenge

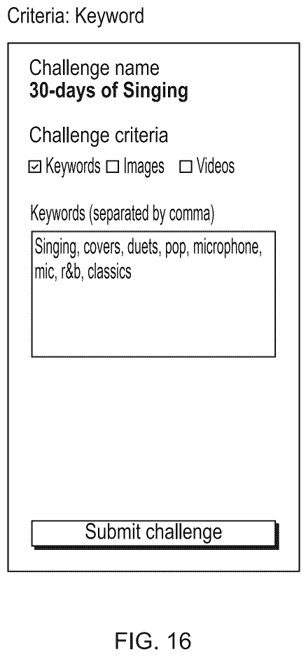

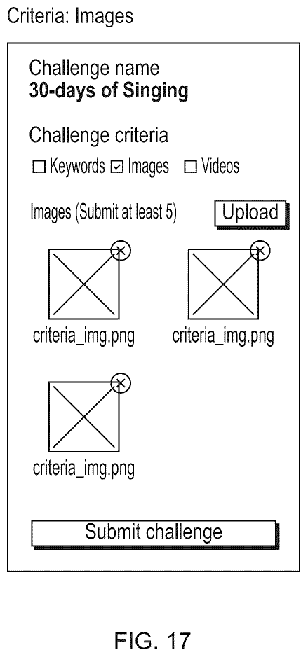

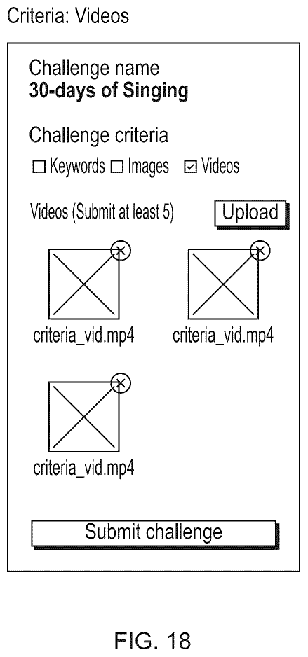

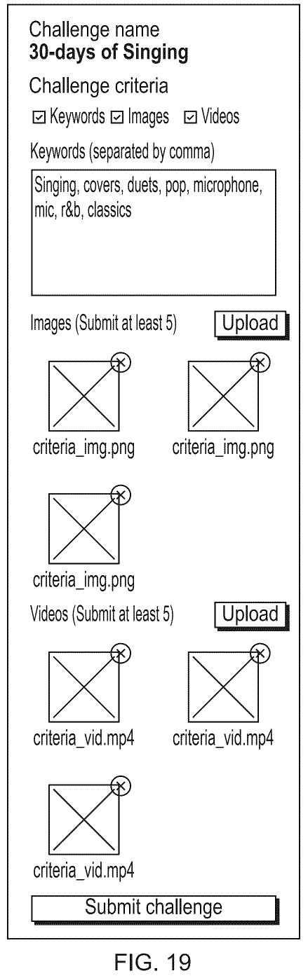

A sponsor may provide guidance information such as challenge criteria for a challenge/contest. Challenge criteria includes keywords, images, audio content, and videos. FIG. 16 shows a schematic view of a user interface (mobile app) screen where keywords are provided by a sponsor for a 30-days singing challenge (FIG. 16). FIG. 17 shows a schematic view of a user interface (mobile app) screen where images are uploaded by the sponsor as part of the challenge criteria. For non-limiting example, in a “World's Best Looking Dog” contest, such images include dog images, as well as images of cats as examples of non-dog images. FIG. 18 shows a schematic view of a user interface (mobile app) screen where videos are uploaded by the sponsor as part of the challenge criteria. For non-limiting example, in a motion-driven contest (e.g., “Dance Like Michael Jackson”), such videos include videos of contestants performing the moonwalk dance. FIG. 19 shows an example of a user interface screen view (mobile app page) where a sponsor sets up a challenge/contest and challenge criteria.

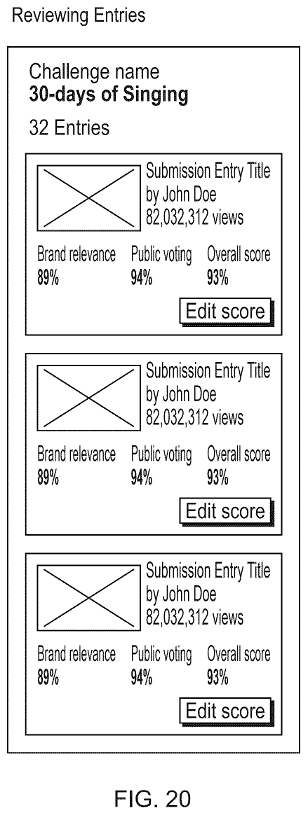

FIG. 20 shows an example viewing page (user interface screen view) where a sponsor can monitor an ongoing challenge contest with voting results and brand relevance score calculated by AI. As shown in FIG. 20, the overall score is a weighted combination of the public voting score and AI sponsor/brand relevance score, where the public voting score is assigned a relative weight of 80% and the AI brand relevance score is assigned a relative weight of 20%. Through the “Edit score” button and corresponding function, the sponsor is allowed to edit the relative weights of the voting score and AI brand relevance score for calculating the overall score.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

For example, where a mobile page is illustrated and described herein, it is understood that a web-based page, browser window or tab, or other online screen view or equivalent is suitable and within the purview of one skilled in the art given the principles of the present disclosure.

What is claimed is:

1. A computer-based contest platform comprising:
(1) an interface module configured to:
(a) receive initial sponsor-provided guidance information regarding a contest;
(b) provide the initial guidance information to contest entrants; and
(c) receive content from the contest entrants,
(2) a voting module configured to:
(a) receive voter feedback from each of a plurality of voters regarding the received content and to generate using the voter feedback a voter ranking of the received content, and
(3) an artificial intelligence module configured to calculate, using an artificial intelligence algorithm, a first degree of alignment between the initial sponsor-provided guidance information and the received content, and to generate, using the first degree of alignment, a first AI ranking of the received content; the interface module displaying an indication of winner of the contest as a function of generated rankings output from both the voting module and the artificial intelligence module.

2. The contest platform of claim 1, further comprising:
(4) a ranking comparator, configured to:
(a) compare the voter ranking and the first AI ranking of the received content; and
(b) identify outlier content from the comparison between the voter ranking and the first AI ranking,
wherein the interface module is further configured to receive updated sponsor-provided guidance information based on the sponsor's evaluation of the outlier content, and
wherein the artificial intelligence module is further configured to calculate, using artificial intelligence, a second degree of alignment between the updated sponsor-provided guidance information and the received content, and to generate, using the second degree of alignment, a second AI ranking of the received content.

3. The contest platform of claim 1, wherein the contest winner is selected based on a weighted combination of the first AI ranking and the voter ranking.

4. The content platform of claim 2, wherein a contest winner is selected based on (i) a weighted combination of the second AI ranking and the voter ranking, or (ii) the second AI ranking.

5. The content platform of claim 1, wherein the received content comprises videos, photographs, written works, musical works, images, textual materials, video stream, live visual content, audio content, or a combination thereof.

6. The content platform of claim 1, wherein the initial sponsor-provided guidance information comprises keywords, images, audio content, and videos.

7. The content platform of claim 1, wherein the interface module is coupled to a graphical user interface.

8. The content platform of claim 1, wherein the voter feedback comprises pairwise comparison of the content, scoring of the content, or a combination thereof.

9. A computer-implemented method of evaluating media content, the method comprising:
receiving, in memory, (i) content from contest entrants, and (ii) voter feedback from each of a plurality of voters regarding the received content;
generating using the voter feedback a voter ranking of the received content; and
calculating, using artificial intelligence, a first degree of alignment between an initial sponsor-provided guidance information and the received content, and generating, using the first degree of alignment, a first AI ranking of the received content.

10. The computer-implemented method of claim 9, the method further comprising:
comparing the voter ranking and the first AI ranking of the received content;
identifying outlier content from the comparison between the voter ranking and the first AI ranking; and
calculating, using artificial intelligence, a second degree of alignment between the updated sponsor-provided guidance information and the received content, and generating, using the second degree of alignment, a second AI ranking of the received content.

11. The computer-implemented method of claim 10, the method further comprising selecting a contest winner based on (i) a weighted combination of the second AI ranking and the voter ranking, or (ii) the second AI ranking.

12. The computer-implemented method of claim 9, wherein the received content comprises videos, photographs, written works, musical works, images, textual materials, video stream, live visual content, audio content, or a combination thereof.

13. The computer-implemented method of claim 9, wherein the initial sponsor-provided guidance information comprises keywords, images, audio content, and videos.

14. The computer-implemented method of claim 9, wherein the interface module is coupled to a graphical user interface.

15. A computer program product for evaluating media content, the computer program product comprising at least one non-transitory computer-readable storage medium providing at least a portion of computer code instructions that, when executed by a processor, cause an apparatus associated with the processor to:
a) receive (i) content from contest entrants, and (ii) voter feedback from each of a plurality of voters regarding the received content;
b) generate using the voter feedback a voter ranking of the received content; and
c) calculate, using artificial intelligence, a first degree of alignment between an initial sponsor-provided guidance information and the received content, and to generate, using the first degree of alignment, a first AI ranking of the received content.

16. The computer program product of claim 15, wherein the computer program product comprising at least one non-transitory computer-readable storage medium providing at least a portion of computer code instructions that, when executed by a processor, cause an apparatus associated with the processor to further
d) compare the voter ranking and the first AI ranking of the received content;
e) identify outlier content from the comparison between the voter ranking and the first AI ranking; and
f) calculate, using artificial intelligence, a second degree of alignment between the updated sponsor-provided guidance information and the received content, and to generate, using the second degree of alignment, a second AI ranking of the received content.

17. The computer program product of claim 16, wherein the computer program product comprising at least one non-transitory computer-readable storage medium providing at least a portion of computer code instructions that, when executed by a processor, cause an apparatus associated with the processor to further select a contest winner based on (i) a weighted combination of the second AI ranking and the voter ranking, or (ii) the second AI ranking.

18. The computer program product of claim 15, wherein the received content comprises videos, photographs, written works, musical works, images, textual materials, video stream, live visual content, audio content, or a combination thereof.

19. The computer program product of claim 15, wherein the initial sponsor-provided guidance information comprises keywords, images, audio content, and videos.

20. The computer program product of claim 15, wherein the interface module is coupled to a graphical user interface.
